(19) United States
(12) Patent Application Publication
(10) Pub. No.: US 2006/0195239 A1
(43) Pub. Date: Aug. 31, 2006

(54) System for limiting received audio

(76) Inventors: Detlef Teichner, Konigsfeld (DE); Joachim Wietzke, Karlsruhe (DE)

Correspondence Address: BRINKS HOFER GILSON & LIONE, P.O. BOX 10395, CHICAGO, IL, 60610, US

(21) Appl. No.: 11/283,547

(22) Filed: Nov. 17, 2005

(30) Foreign Application Priority Data
Nov. 17, 2004 (EP) 04027291.6

(51) Int. Cl. G06F 19/00

(52) U.S. Cl. 701/36; 701/213

(57) ABSTRACT

A vehicle entertainment and information processing (VEIP) system may allow a user to listen to quality broadcast signals while moving through regions of varying signal strength. The VEIP system includes a navigation unit, a tuning receiver, and a system controller to analyze broadcast signals based on a broadcast station database. The VEIP system may switch to alternate broadcast stations when the broadcast signal degrades because of terrain, position of the vehicle, or other driving conditions.

### PRIORITY CLAIM

This application claims the benefit of priority from European Application No. 04027291.6, filed Nov. 17, 2004 which is incorporated herein by reference in its entirety.

### BACKGROUND OF THE INVENTION

1. Technical Field

This invention relates to broadcast reception in automotive systems. In particular, this invention relates to filtering received audio based on position.

2. Related Art

Information and entertainment systems in mobile vehicles, such as automobiles, ships or aircrafts may often be included with the vehicle. Customers may desire a multi-media entertainment and information processing system in their automobiles to receive messages or entertainment programs promptly and at a low cost. Vehicles may also have navigation systems that provide position information, such as route or traffic information. The navigation system may be integrated within a vehicle to display information to the driver or other passengers.

Because the navigation system is often provided by manufacturers that are different from manufacturers of other components of the vehicle, satisfactory integration of the navigation unit with the remaining components of the vehicle entertainment and information processing system has not yet been accomplished.

### SUMMARY

A vehicle entertainment and information processing system provides a tuning receiver for receiving broadcast signals from a broadcast station, a navigation unit that receives position data and outputs the position data in real-time based on the vehicle's movement, a memory that stores broadcast station information, and a system controller that determines a reception quality parameter of the broadcast station related to the position data and the broadcast station information.

A method for improving broadcast reception in a vehicle entertainment and information processing system receives broadcast signals from a broadcast station, receives geographical location coordinates from a global positioning system unit, obtains broadcast station information from a database, and obtains a reception quality parameter of the broadcast station related to the position data and the broadcast station information.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of a vehicle entertainment and information processing system.

FIG. 2 is a broadcast station database.

FIG. 3 illustrates basic control operations of the system.

FIG. 4 illustrates a process carried out at a tuning receiver.

FIG. 5 illustrates an example local database.

FIG. 6 is a process for obtaining data for the local database through a television receiver.

FIG. 7 is a second example local database.

FIG. 8 is an example road portion illustrating a learning mode.

FIG. 9 illustrates a switching operation when a vehicle travels along a route.

FIG. 10 presents an example broadcast station database.

FIG. 11 illustrates a mobile communication unit.

### DETAILED DESCRIPTION OF THE PREFERRED EMBODIMENTS

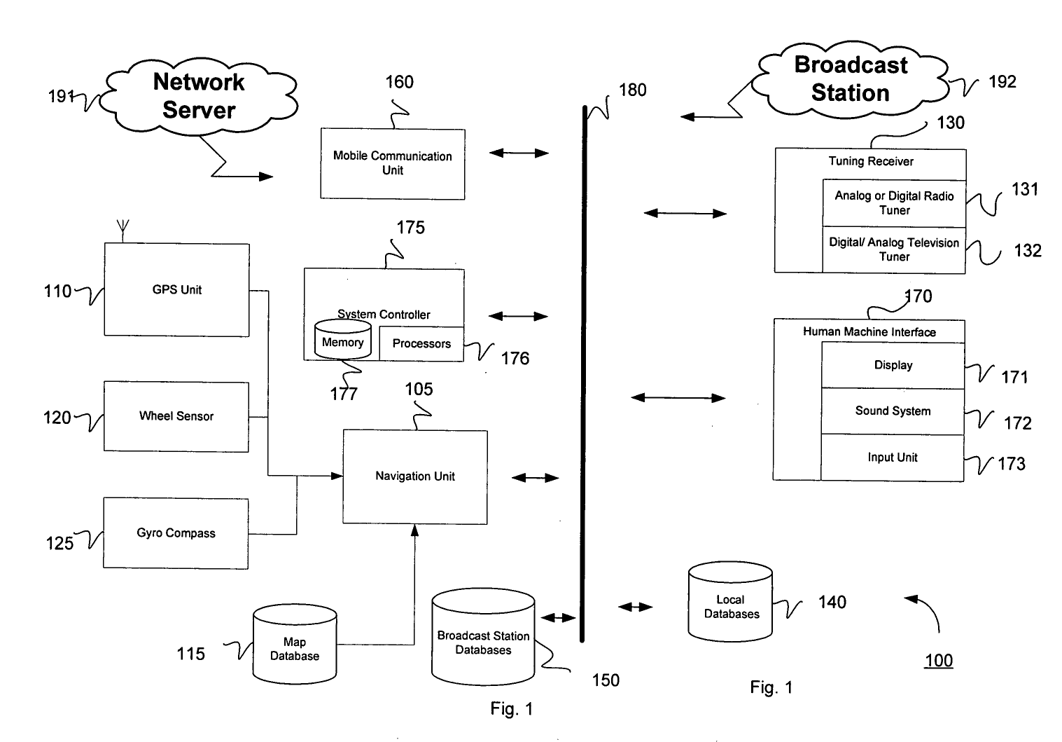

FIG. 1 illustrates a vehicle entertainment and information processing system (VEIP system) 100. The system 100 may include a navigation unit 105, a unit for providing location measurements, such as a global positioning system (GPS) unit 110, a map database 115, units that provide movement measurement, such as a wheel sensor 120 and a gyro compass 125, units that receive broadcast reception, such as a tuning receiver 130, an analog AM/FM or digital DAB (digital audio broadcast) tuner 131 or an analog or digital television tuner 132. The system 100 may include databases for storing data on broadcast stations 140 which may include a database for storing parameter data on broadcast stations 150. The system 100 may include a mobile communications unit 160, such as a cellular telephone, portable electronic device, handheld unit, wireless-configured laptop computer, or other electronic devices configured for communications. The system 100 may receive inputs from a network server 191 or a broadcast station 192.

The system 100 may also include an interface for accepting commands from a user and displaying information to the user, such as a human-machine-interface (HMI) 170. The HMI 170 may include a front display 171, a sound system 172 and an input unit 173, which may typically be a keyboard, a touch screen and/or a speech recognition module. The sound system 172 and/or display 171 may be installed as a separate unit or module. The front display 171 may be a liquid crystal display (LCD), cathode ray tube (CRT), organic lighted electronic diode (OLED) display, thin film transistor (TFT) display, or other display screen. The sound system 172 may include one or more loudspeakers in communication with the system 100, either integrated with the system 100 or connected externally to the system 100. The sound system 172 may be integrated with an electronic device in communication with the system 100. The input unit 173 may include haptic interfaces, voice recognition and/or text-to-speech (TTS) interfaces, computer display softscreen inputs, or keypads in communication with the system 100.

The system 100 may include a system controller 175. The system controller 175 may include one or more microprocessors 176 and a memory 177. The memory 177 may control the communication between the various components and perform the necessary control functions and interactions during operation of the VEIP system 100. The memory 177 may store the software for various applications or user specific data, such as preferred parameters or adjustments. The system controller 175 may be alternatively implemented as part of the HMI module 170 including the memory 177 or as part of the tuning receiver 130.

The components of the VEIP system 100 may communicate over a data bus 180, which may be a copper-wire system or an optical glass fiber bus using a network protocol, such as the media-oriented system transport (MOST) protocol. The bus 180 may have a ring-shaped structure. The bus 180 may also include wireless connection and communication protocols, such as Bluetooth, Infrared Direct Access (IRDA), WiFi, or radiofrequency communications.

The navigation unit 105 may receive position data, such as geographical coordinates from the GPS unit 110 and from a database 115 containing map data. The data provided by GPS unit 110 may include geographical coordinates in standardized form, which may be detected in real time according to the vehicle's location and movement using satellite communication. Modern GPS systems may have a precision of up to a few meters. The navigation unit 105 may receive the user's input relating to a destination, calculate the respective route, and output map data and/or indications for guiding the user along the route from a start point to the desired destination.

The map database 115 may include mass storage devices, such as flash memory, memory cards, compact disc read-only memory (CD ROM), digital versatile disc (DVD), floppy disks, Zip, Jazz, or Syquest drives, and/or other semiconductor memory devices to provide map data relating to a geographical location, such as route data, information on particular points of interest for the user (POIs), such as shops, restaurants, sightseeing spots, gas stations, or parking areas, along the route, or the altitude of a geographical location. The map database 115 may be either fully integrated in the navigation unit 105 or may be contained in a device external to the navigation unit 105 which may be able to read/write digital data on a storage medium. The database 115 may also be provided local to the receiver.

The navigation unit 100 may receive and decode geographical GPS coordinates and may analyze the information provided by the wheel sensor 120 and the gyro compass 125 to calculate position and route data. By using the map data provided by the database 115, the navigation unit may output map data showing the present location and the vicinity around the vehicle.

The analog AM/FM or digital audio broadcast (DAB) tuner 131 or the analog or digital television tuner 132 may provide entertainment to the vehicle's driver and passengers. The tuning receiver 130 may receive broadcast signals of a broadcast station selected by the user. The receiver may search the frequency band for available broadcast stations, and may provide a list of available stations and tune the tuning receiver 130 to a selected station. The tuning receiver 130 may simultaneously search the frequency band during reproduction of a program for further available stations, or may continuously scan the available frequency band for broadcast stations with good reception properties through a background tuner (not shown). To assist the search operation, the tuning receiver 130 may decode additional information provided in the broadcast signal, such as digital data included in the broadcast station signal. For instance, digital radio receiver information may be included in a Radio Broadcast System (RBS) data stream for providing traffic information, broadcast information, news, weather alerts, and other station identification information.

The data from the received broadcast stations data may be stored in local databases 140. The system 100 may include a broadcast station database 150 that may store data on television and/or radio broadcast stations including frequencies, names and position information of the broadcast stations, and other parameters related to the television and/or radio broadcast stations. The databases 140 and 150 may be installed as integral parts of the tuning receiver 130, for example, as computer-readable code or data stored on a non-volatile memory such as secure digital random access memory (SD-RAM), flash memory, electronically programmable read-only memory (EPROM), hard disk, rewritable removable media such as disc media, or as any part of the system 100.

Broadcast stations transmitting a program may be identified by their station ID (such as their PI-Code in the radio broadcast RBS System, or, in the case of a television tuner, the video text signal may provide a channel ID for this purpose). The database 115 may be structured or ordered either automatically or according to the user's preferred selection for desired broadcast stations or their operational parameters.

VEIP system 100 also may includes a mobile communication unit 160, such as a mobile telephone, either as an integrated communication unit or in the form of a handheld mobile telephone, which may be connectable to the system by a wired or wireless interface means. The mobile communications unit 160 may include a cellular telephone, a portable electronic device configured for communications, a wireless-configured laptop computer, or other wireless or wired electronic devices configured for communication. The vehicle may receive speech and data signals according to an applicable standard, such as Global System for Mobile Communications (GSM), Universal Mobile Telecommunications System (UMTS), code division multiple access (CDMA), or other communication protocols. The mobile communication unit 160 may communicate wirelessly within a cellular network system, including broadcast stations (called base stations) that may receive and/or send speech or data information to and from other wireless or wired communication units, such as a network server 191 or user terminals.

The HMI 170 may output route and/or traffic information in visual form on a display 171. The display 171 may be a separate display for outputting this information or may be a split-screen display showing information together with operational information of other components of the system, such as data relating to the audio system, or warning messages relating to a hazardous condition or the position of the vehicle. The route and/or traffic information may be output as audible signals, which may be generated by a voice generation module and output by the sound system 172.

The system controller 175 may control the communication between the various components and may perform the necessary control functions and interactions during operation of the VEIP system 100. The memory 177 may store the software for various applications or user specific data, such as preferred parameters or adjustments. The system controller 175 may be implemented as part of the HMI 170, as part of the memory 177, or as part of the tuning receiver 130.

The VEIP system 100 or the individual components may be integrated in a single device in a vehicle, such as a head unit. The system 100 may also be implemented with microprocessors, embedded microcontrollers, application-specific integrated circuits (ASICs), as logic implemented in computer-readable code or as algorithms implemented in electronic circuitry.

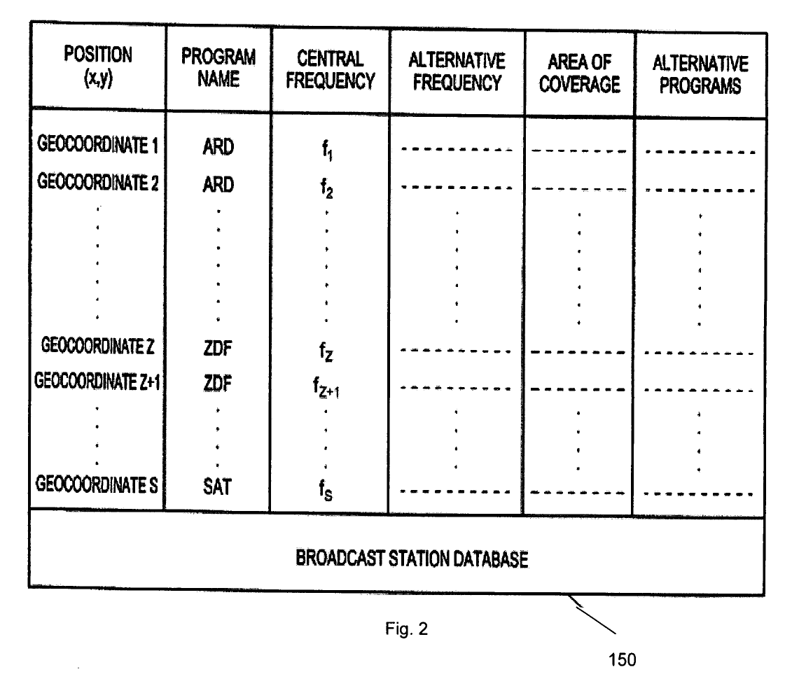

FIG. 2 illustrates the data stored in the broadcast station database 150. The data may include broadcast station information for radio or television reception such as program name, position such as geographical coordinates, broadcast transmission power, area of coverage, alternative frequencies, program identification code, program type code, listings of alternative programs, or other parameters related to broadcast station information. The data contained in the broadcast station database 150 may be ordered according to the geographical coordinates or according to the available programs. Position data and frequencies may be listed as one data block followed by data blocks for other programs.

The broadcast station information data may be collected on the basis of publicly available information and may already exist when the VEIP system 100 is constructed. The database 150 may be implemented in mass storage, such as flash memory, a memory card, a hard disk, a floppy disk, Zip, Syquest, or Jazz media, a CD-ROM or a DVD similar to the implementation of database 140.

The information provided by broadcast station database 150 may be used by the tuning receiver 130 during its collection of information relating to radio broadcast stations. The information may be updated during maintenance operations by installing an updated version of the database 150. The database update may be performed remotely, such as over a network in communication with the system 100, through a network server 191, through a wired interface in communication with the system 100, through a wireless connection to the system 100, such as through a WiFi, WiMax, radiofrequency (RF), Bluetooth, IRDA, or other wireless protocol, or through update via a storage medium such as a memory card, floppy disk, flash memory module, or removable media such as a CD or DVD.

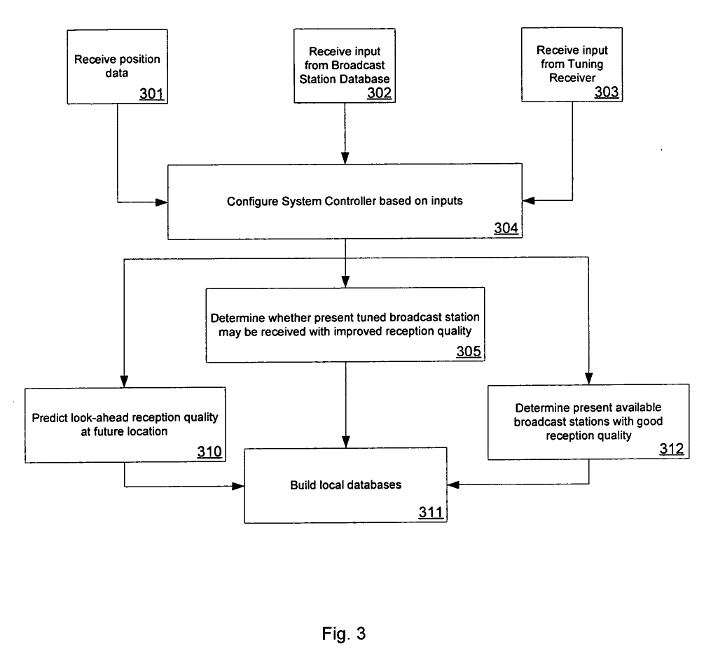

FIG. 3 illustrates a process to control operations carried out at the system controller 175. The system controller 175 may receive position data from the navigation unit 100 at block 301, receive input data from the broadcast station database 150 at block 302, and receive tuning and measurement data from the tuning receiver 130 at block 303. At block 304, the system controller 175 may be configured based on the inputs received from blocks 301-303. Configuring the system controller 175 may include initializing parameters associated with the system 100 operation, loading related data or pointers to data from the memory 177, processing the input data by the processors 176, or requesting input from other components of the system 100.

The controller 175 may determine a reception quality parameter for the available broadcast stations with acceptable reception characteristics at block 312. The user may be presented a list of currently available broadcast stations for the present location, such as through a display 171 or sound system 172 of the HMI 170. The system controller 175 may also determine at block 305 whether the tuned broadcast station may be received with improved reception quality, using other broadcast station data parameters, such as an alternative frequency of a different broadcast station of a network of stations transmitting the same program. The system controller 175 may be able to predict broadcast reception quality at a different location than the present one (i.e., a look ahead function) such as a future position of the vehicle according to the calculated route, using the position data and the broadcast station information, at block 310.

The system 100 may use the information obtained by blocks 305, 310, and 312 to build the local databases 140, as shown at block 311. The information from blocks 305, 310, and 312 may be used in whole or in part to build the databases 140. The system 100 may store the information in real-time, or may cache the information in the system controller memory 177, or other memory resident to or interfaced to the system 100.

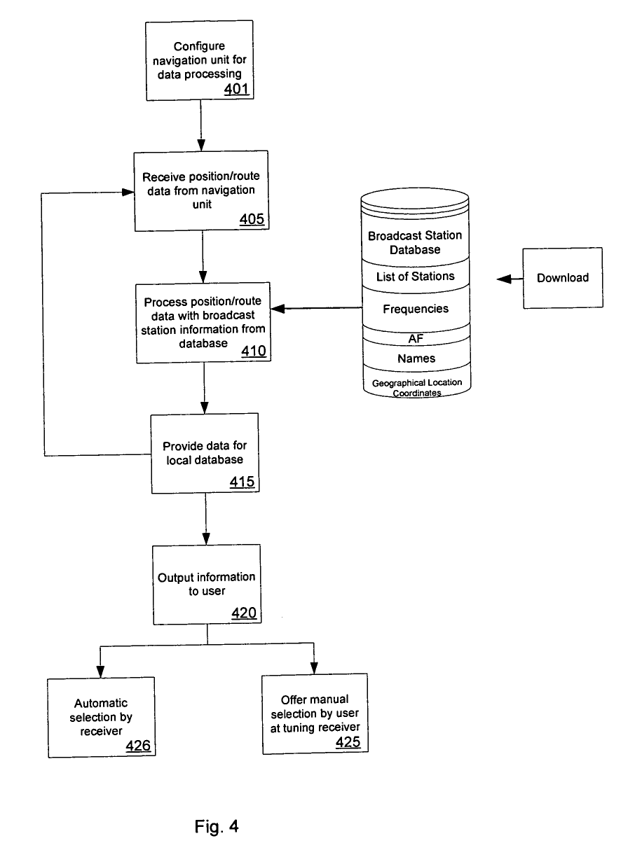

FIG. 4 illustrates an example process for optimizing the performance of the tuning receiver 130 using the position and broadcast station data. The system 100 may configure the navigation unit 105 for data processing, such as by initializing the navigation unit 105 to receive GPS 110 information or information from the wheel sensor 120 or the gyro compass 125, at block 401. The system 100 may receive data from the navigation unit 105, such as position information data, at block 405. The system 100 may compare the received data with broadcast station information previously stored in the database 150, at block 410. The broadcast station information may include a list of stations, station frequencies, alternative frequencies (AF), names, program identification codes, reception quality parameters, geographical location coordinates of the broadcast stations and/or their areas of coverage (e.g. radius of a circular or other shaped area of coverage). This data may be structured in the form of one or more tables for each of the radio or television broadcast stations as illustrated in FIG. 2.

The system 100 may correlate the position data, at block 410, obtained from the navigation unit in block 405, with the geographical location coordinates for the broadcast stations and their geographical coverage area. Two different data configurations may require comparison. In some systems, the data compared may include the position data output by the navigation unit 105 (which may be a one-dimensional data string) with the coverage area (which may be a two or more dimensional array). A matching algorithm may be implemented by using the method of minimal distances for the distance between the present location and the broadcast station. Other matching algorithms, which process parameters such as transmission power, shape and geographical extensions of the coverage area, may be implemented.

The tuning receiver 130 may provide data for the local database 140, at block 415. The data may relate to the current location, such as a list of available broadcast stations for the present location and its reception characteristics related to the actual position data delivered from the navigation unit 105. Stored information available for broadcast stations may be processed, as well as the results of the tuning operation and the reception measurements. The results obtained from the comparison operation of block 410 and a reception quality parameter for the location of the vehicle may be stored in the local databases 140 and accessed by the tuning receiver 130.

The list of broadcast stations provided in block 415 may be presented by the HMI 170 to the user in audible form or visual form on a screen at block 420. The user may make a manual selection at block 425. The calculated results may be automatically used by the tuning receiver 130 for selection of the appropriate broadcast station, at block 426. The blocks 405-415 may be repeated to have the data for the local databases 140 continuously updated for the vehicle's current location. In some systems, the pre-installed database 150 may be updated periodically by establishing an online telephone connection or by reading a data storage medium, such as an IC memory card, a CD ROM, DVD, flash memory, memory chip module or other removable storage media. The database 150 may be updated by a broadcast signal. The digital RBS data stream may be used for wireless updates. For digital television systems, a regular download may be provided by an auxiliary data channel of the DVB-T system. The database update may be downloaded, such as at regular service intervals of the vehicle for maintenance operations performed by a dealer or maintenance service. Other methods of update include updates over satellite transmissions, communication with portable electronic devices, handsets, cellular telephones, laptops, or other wireless devices that may contain data to use for the database update.

The system 100 may provide more detailed information through the steps illustrated in FIG. 4. The tuning receiving 130 may provide better signal exploitation, and the system controller 175 may build local databases with high accuracy. In addition, there may be less need to provide a background tuner, which may be provided for scanning and obtaining the digitally encoded information. By using the data of the local databases 140, a scanning operation may be initiated and completed in a short time. The method may allow the tuning receiver 130 to more accurately and quickly switch to the broadcast station with the optimal reception quality parameter. The tuning receiver 130 may also require less hardware. If a background tuner is provided to avoid audible muting, scanning for a good broadcast station candidate may be more efficient, as the system 100 may not need to linearly scan the frequency band, but rather may test only those broadcast stations with satisfactory reception quality parameters. Fewer test operations may be needed, which may allow testing of promising candidates, with an even longer time interval before performing an actual switch over operation to the candidate station.

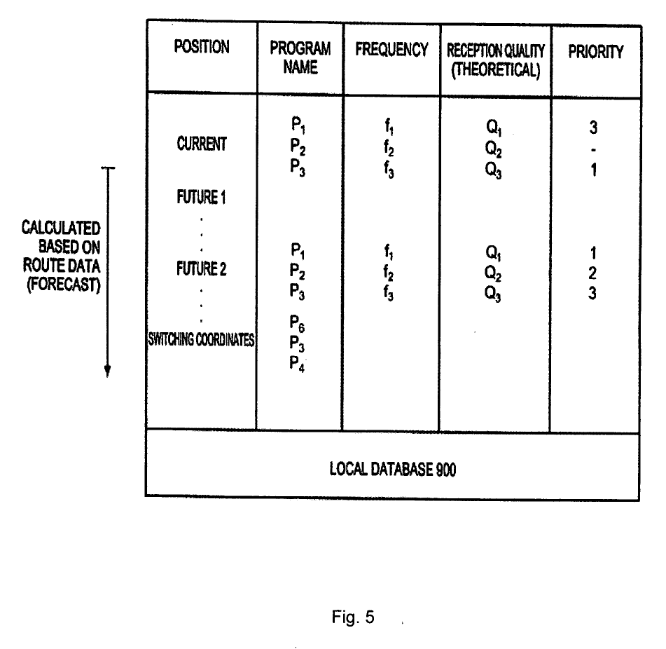

FIG. 5 illustrates an example database for a VEIP system 100. Position data may be provided from the navigation unit 105, as well as route data. Route data may include a route previously determined and input into the navigation unit using the HMI 170. Route data may include a destination to which the user would like to travel. The navigation unit 105 may use the map database 115 to calculate route data, such as the shortest distance, fastest route, or other routes based on specified parameters. Based on the GPS data and the route data, the system controller 175 may calculate position data for a particular route. When correlating the route data with the broadcast station information from the database 150, the system controller 175 may build a local database 140. The local database 140 may list the available broadcast stations by name, their frequencies, their theoretical reception quality parameters, such as field strength and a priority resulting from their positions. The controller 175 may calculate position coordinates for a switching operation. The switching operation may be related to frequency and/or program feasibility, such as when the signal at a given frequency, or for a given program reaches a determined strength or ratio. The database 140 may be built, which may provide forecast data associated with the reception parameters for a calculated route.

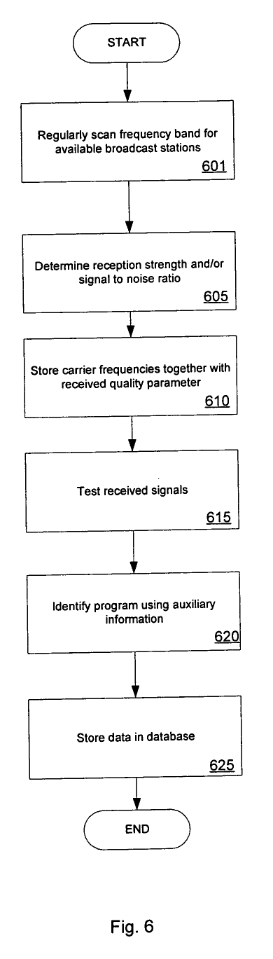

FIG. 6 illustrates an example process for collecting data for broadcast stations with good reception quality in a television receiver at the vehicle's present location. The background tuning unit may periodically or continuously scan the frequency band for available broadcast stations, at block 601. In some systems, a background tuning unit is responsible for the scanning process as well as for obtaining the audio signal. The television tuner 132 may be responsible for real time reproduction of TV programs. The system 100 may determine whether the reception strength and/or the signal-to-noise ratio is of sufficient reception quality, at block 605. The system controller 175 stores the determined carrier frequencies in a local database 140 together with the carrier frequency quality parameters, such as the field strength or signal/noise ratio, in block 610. The received signal may be tested, at block 615, to determine whether it is a television signal by checking whether it contains an H-sync signal with a time interval of 64 microseconds or a V-sync signal with a frequency of 50 to 60 Hz. The system 100 may determine whether the signal contains an audio signal by determining whether the audio carrier has a relationship to the frequency carrier for the video signal. The tuning receiver 130 may identify the program, at block 620, such as by using a channel identification code contained in the video programming system (VPS) signal, the program delivery code (PDC) signal or a universal time code (UTC) signal. The system controller 175 may correlate the audio and/or video signals received with those obtained by the scanning operation of known channels to identify channels broadcasting the same program. The system controller 175 may store a list of available stations in the database 150, at block 625.

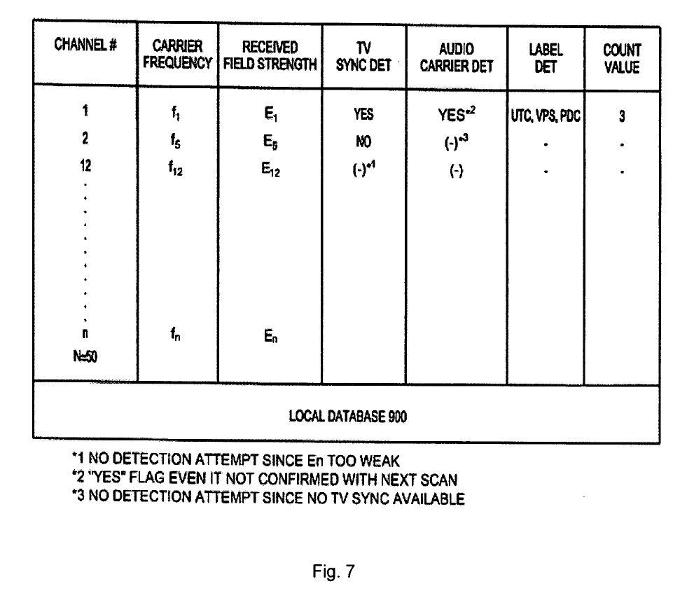

FIG. 7 illustrates an example structure of a local database 140 for a tuning receiver 130, such as a television receiver 132. In the initial column, the channel number may be indicated. There may exist up to 50 or more channels in the total available frequency band. In the second column, the carrier frequency for each channel may be stored. The data items in the third column may represent the received field strength for each channel as an absolute value. If the field strength is below a predefined threshold, the system 100 may not attempt to detect a synchronization signal, because the low field strength may not warrant a detection operation. This example is illustrated in the third column of the table with an entry of field strength value En. In the column indicating the synchronization detection, a flag indicating “yes” or “no” or “-” may indicate a successful synch detection as conducted in block 615 in FIG. 6. In this system, a “yes” flag may be set even if this can not be confirmed within every successive scan, because of temporary fluctuations in the reception quality. In the fourth column, the results of block 620 from FIG. 6 are indicated. These may include the identification of a program or correlation of audio/video signals. The audio carrier and label detection may not be not carried out if a synchronization signal has not been successfully detected in the previous block 615. A count value may be entered into the database 140 if a channel may be received with good reception quality or whether temporary distortions do not allow proper detection during scanning.

The controller 175 may determine to update the list associated with the count value, t. In some systems, the controller 175 may remove or add certain channels in order to have the list updated according to the position of the vehicle. The count value may serve as a parameter for determining whether a program may be displayed at the HMI 170, offering a program for selection.

The process illustrated in FIG. 6 may be carried out for a tuning receiver 130 such as an analog AM/FM tuner 131. The test in block 615 on the received signal may be carried out using a test parameter. The identification block 620 may be carried out using the program identification (PI) code, which may allow a unique identification of the received broadcast program in the decoded RDS data stream.

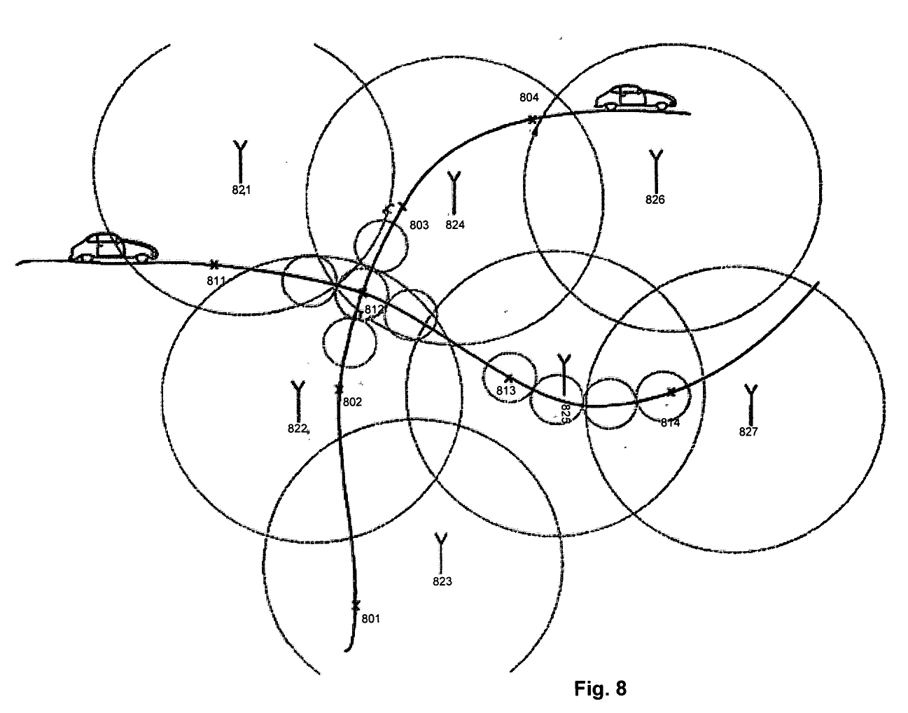

FIG. 8 illustrates the radio tuning receiver 131 operation, where a vehicle travels through a geographical area. A first route may be defined by route data represented by reference points 801, 802, 803, 804 and a second route may be defined by reference points 811, 812, 813, 814. A vehicle traveling along these routes may pass through the area of coverage of various broadcast stations indicated by 821 to 827. The broadcast stations 821, 822 and 823 may belong to a network chain and broadcast the same program P1. The broadcast stations may broadcast on different frequencies, or alternative frequencies (AF). Stations 824-827 may belong to a different network chain, where all stations broadcast the same program different from program P2, which is broadcast by stations 821-823.

When the user travels along the route, the actual position data may be determined by the GPS unit 110. When comparing the position data with the information obtained from the broadcast station database 150, the tuning receiver 130 may determine which broadcast station at which frequency is optimal for reception. The tuning receiver 130 may process broadcast station information obtained by reception of the present broadcast signal. In this system, when approaching an area where the coverage by the broadcast station 821, for example, is at its limits and the reception of the signal by the broadcast station 822 is optimal, the tuning receiver 130 may perform a switch over operation, related to the data from the database 140. The system controller 160 may determine the reception quality in advance and may predict the reception quality in the future, such as for a particular location where reception from station 822 is optimal. The system 100 may provide a higher accuracy for frequency switch over. The frequency switchover operation may be improved in speed and unnecessary switching may be avoided. Once the switching coordinates have been determined as satisfactory, they may be stored in the database 140.

In this system, the user may take the route defined by reference points 801-804. The best broadcast stations in reception quality would be 821, 822, 825, 827, in this order. The order of switching may be calculated from the database 140 or may be obtained by reception measurements made by having the tuner scan the frequency band for the best reception.

If the user now travels along the route, he may reach the limits of the area of coverage for station 822. The geographical coordinates obtained from the navigation unit 105 are compared with the information obtained from the database 140. The tuning receiver 130 may prepare in advance for a switch-over operation to another station of the same network chain. In this system, no such station may be available, which results in the receiver 130 switching to another network chain broadcasting a different program P2, i.e. the program broadcast by stations 824-827. In this system, the receiver 130 may tune to the frequency of station 825, then to that of station 827. The point at which optimal switch-over may be performed may be predicted based on the determination of the geographical coordinates. In FIG. 8, reference point 814 may constitute the optimal switch-over point for a transfer from base station 825 to 827.

If the user takes the route 801 . . . 804, the respective broadcast station order would be 823, 822, 824, 826. This sequence requires a switch-over operation not only of alternative frequencies, but also to a program broadcasted by a different network chain. At the location indicated by reference point 812, the reception quality of broadcast station 824 is approximately equal to that of broadcast station 822. From the local database 140, the receiver may determine that station 824 may belong to a different network and therefore does not constitute a preferred selection for the user to maintain his program. The receiver 130 may not switch to broadcast station 824 or even test this broadcast station, as long as the user receives a program with acceptable reception quality parameters,.

If acceptable reception quality parameters are not possible even after processing alternative frequencies of broadcast stations belonging to one of the same broadcast station network, the receiver 130 may output a message to the user indicating that the received program is at its limits of reception. The tuning receiver 130 may switch to a different program broadcast by a different network by a default adjustment. In this system, in response to the warning message, the user may be presented with the available programs and broadcast stations. A stored user profile may be used to indicate the user's preferred selection.

In some systems, the system controller 175 may not immediately perform the switch-over to an alternative frequency based on the information obtained from the local database 140. The station with the alternative frequency may be first tested by a fast switch “back and forth” operation, which might be inaudible for the user, or by a background tuner, which may carry out tests in advance on prospective candidate stations along the route. In some systems, faster and more accurate switching operation may allow reduced hardware requirements by omitting the background tuner. Testing for alternative broadcast stations may be made by allowing a thorough test of broadcast station candidates rather than linearly scanning the frequency band.

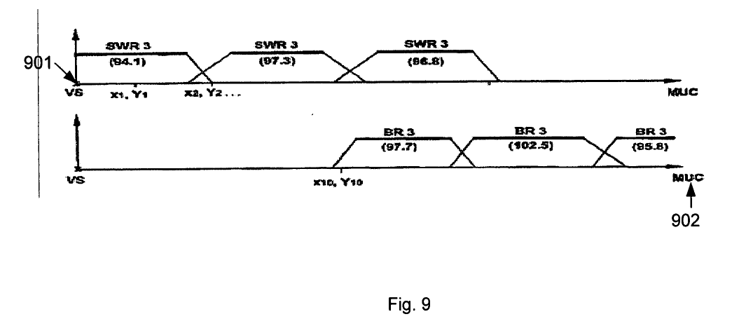

FIG. 9 illustrates an example broadcast station switching operation. FIG. 9 depicts the reception quality along a first route defined from a geographical location indicated by 901 to another geographical point 902. Along this route, the user may experience a certain level of reception quality from broadcast station, identified as SWR3. When starting at point 901, the program is best received at reception frequency 94.1 kHz. At a certain distance from the start point, the reception quality at this frequency may decrease, while this program may be received from an alternative broadcast station at the alternative frequency of 97.3 kHz, with improved reception quality. When traveling further along the route, there will be a third broadcast station broadcasting the program SWR3 with a frequency of 96.8 kHz.

the lower plot of FIG. 9, the reception quality for a different program BR3 is indicated, which may not be received at location 901, but around the geographical area of 902. The respective frequencies are indicated in the diagram as 97.7 kHz, 102.5 kHz and 95.8 kHz. The frequency values have been chosen as examples. In some systems, the receiver 130 is implemented as a “learning receiver.” Route data defined by reference points is compared with the information of the local database 140. An adjustment strategy may be implemented for routes repeatedly taken. A high capacity memory may be provided either locally in the tuner 130 or within the system control unit memory 177, to provide sufficient storage space for the data associated with route, reference points and broadcast station information.

In the learning mode, broadcast information may be stored in relationship to geographical data in a database, which may be either a reserved area in local database 140 or a separate memory. The database may be either string- or area-oriented. In area-oriented databases, the geographical space is subdivided in spatial areas such as squares or circles. The receiver 130 may build a table of geographical areas, in which a particular broadcast station of good quality may be received. The database 140, with the system controller 175, may build a broadcast station map indicating the channels that may be received and boundaries where a switchover operation to a different channel should be performed. The individual spatial areas may be with coarse or high resolution depending on the density of the route data. For a downtown area of a large city, a finer resolution may be chosen, while choosing a coarse resolution for a countryside road.

FIG. 8 may illustrate the learning mode. Between reference points 813 and 814, measurement points by the receiver are indicated by dots having about the same distance from each other. At these measurement points, the reception quality, such as the field strength of the received program, may be measured and stored in the database 140. If the reception quality at two measurement points has a satisfactory level, the tuning receiver 130 may determine that the reception quality is sufficient within a circular area defined by two measurement points. This area may then define a spatial area with acceptable reception quality and the coordinates for such area may be stored in the database 140 for future use. The distance between the reference points may vary dependent on the vehicle's driving condition, such as with velocity, weather, or traffic and/or road conditions.

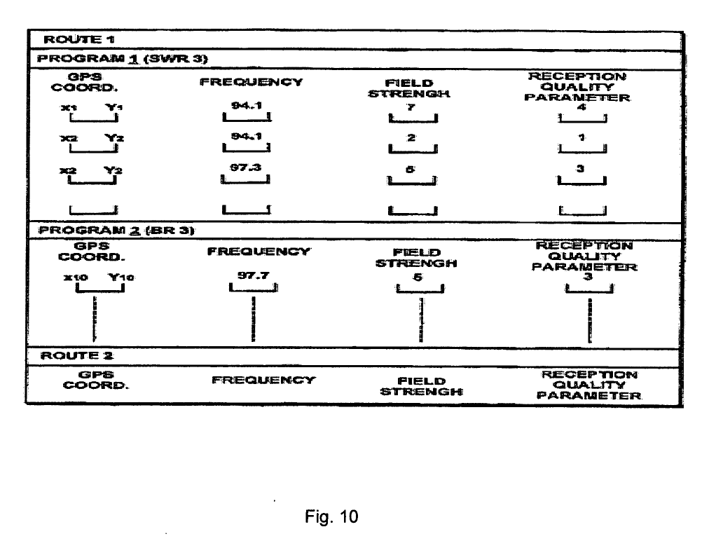

FIG. 10 illustrates a database structure for implementing the learning mode in a one-dimensional or string-oriented structure based on route data. The database 140 may be initially empty. Once the user has defined his route by inputting appropriate selection commands into the navigation unit, the route may be assigned an identifier for future use. If the user has selected program 903 as his preferred broadcast program, data may be entered into the reserved fields. Examples of data include the present GPS coordinates, the tuned frequency and the measured field strength of this program. Other reception quality parameters may also be stored. As indicated in FIG. 10, at a location defined by GPS coordinates (X2, Y2), the field strength from a broadcast station transmitting at 94.1 kHz may be much lower than that broadcast from a different station of the same network at frequency 97.3 kHz. An entry into the database 140 may be made indicating that coordinates (X2,Y2) constitute a switch over point from one broadcast station (94.1 kHz) to another one (97.3 kHz). At a location defined by coordinates (X10, Y10), the tuning receiver 130 may determine that the selected program 903 will no longer be received with satisfactory quality. The tuning receiver 130 or the user, by manual selection, may switch to a different program, such as broadcast program 904. The obtained data from the navigation unit 105 and the tuning receiver 130 may be entered into the database. The receiver 130 may populate the database 140 with reception quality values and broadcast station data. Data for other routes may be entered into the database 140. When the user selects a route for which data has already been stored in the database 140, the relevant data may be retrieved and used by the tuning receiver 160.

The database 140 in FIG. 10 may have different structures depending on the available memory space. In some systems, the table may include switching points associated with the broadcast station. In other systems, several alternative options may be stored, including alternative programs as determined by a background tuner. In those areas where no satisfactory reception is possible at all, the tuning receiver 130 may output a message to the user in advance informing him or her of the expected length of the interruption of the program and other receivable broadcast programs. The receiver 130 may display a pop-up screen and/or a voice message indicating a message, such as “tunnel ahead, no reception of current radio station for X kilometers/miles.” After the vehicle has entered the tunnel and reception diminishes, the tuning receiver 130 may output an image and indicate to the user that reception of the program will resume upon leaving the tunnel.

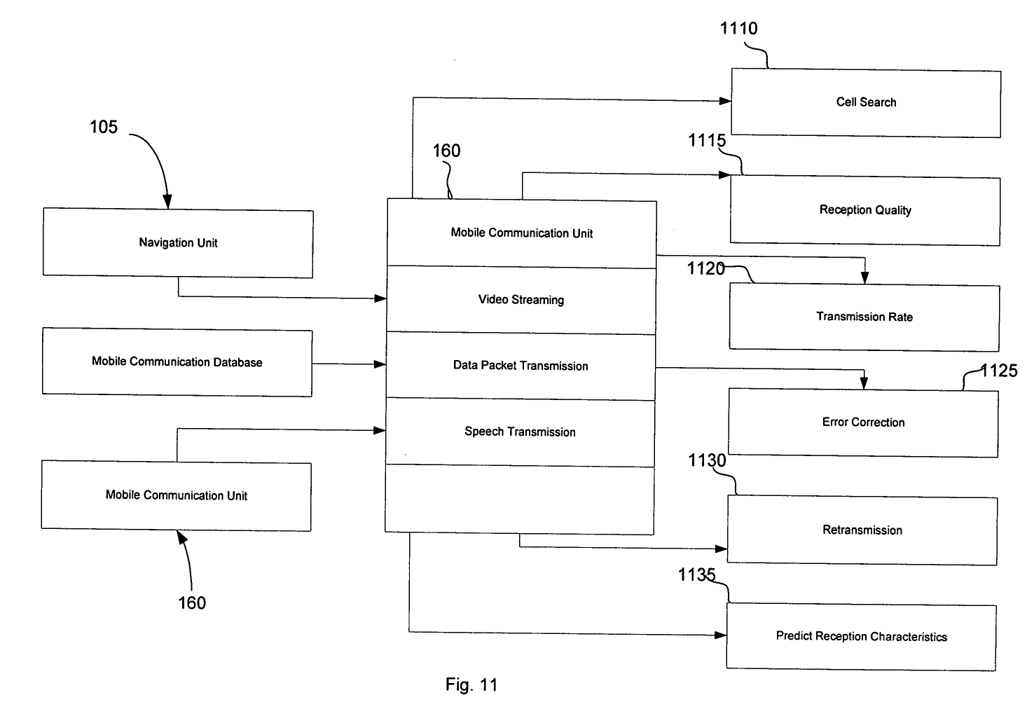

FIG. 11 illustrates an example application for the mobile communication unit 160 of a VEIP system 100. The mobile communication unit 160 may be implemented for speech or data packet transmission, such as for video streaming. Using the position information, the cell search operation may be greatly improved in duration and accuracy, as indicated by block 1110. A mobile communication database may store a list of parameters relating to the broadcast stations and cells of a cellular radio communication system. The position data may then be used to quickly determine the appropriate cell in which the vehicle is located or to present to the user stations of an alternative network.

In some systems, the position data from the navigation unit 105 may be used to improve parameters relating to the reception quality, as indicated by block 1115. The transmission rate, with which radio communication may be performed, may be adapted for the position data. In areas of poor reception quality, the transmission rate may be appropriately reduced in order to maintain good quality reception without increasing the transmission power. This transmission rate control is indicated by block 1120.

An error correction scheme may be implemented using the relevant position data, as indicated by block 1125. In mobile communication systems, the retransmission operation (such as at block 1130) may be improved using the position data in areas of poor reception quality. A higher repetition rate with increased data redundancy may be selected by the receiver 130. The mobile communication unit 160 may predict reception characteristics and may respond accordingly, at block 1135.

Like the flow diagrams shown in FIGS. 3, 4, and 6, the sequence diagrams may be encoded in a signal bearing medium, a computer readable medium such as a memory, programmed within a device such as one or more integrated circuits, or processed by a controller or a computer. If the methods are performed by software, the software may reside in a memory resident to or interfaced to the system controller 175, a communication interface, or any other type of non-volatile or volatile memory interfaced or resident to the system 100. The memory may include an ordered listing of executable instructions for implementing logical functions. A logical function may be implemented through digital circuitry, through source code, through analog circuitry, or through an analog source such as through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any unit that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A vehicle entertainment and information processing system comprising:
a tuning receiver that receives broadcast signals from a broadcast station, where the receiver is tunable to a broadcast station and is configurable to receive and reproduce a broadcast program;
a navigation unit configured to receive geographical location coordinates;
a memory that stores broadcast station information; and
a system controller that determines a reception quality parameter of the broadcast station based on the position data and the broadcast station information.

2. The system of claim 1 further comprising logic for correlating the position data with the broadcast station information and using the correlation in scanning and reception of the tuning receiver.

3. The system claim 1 where the reception quality parameter comprises a measure for a reception strength, an interference measurement or a signal-to-noise ratio of a received broadcast program.

4. The system of claim 1 where the memory comprises a database that stores the reception quality parameter for the broadcast station in relation to a position.

5. The system of claim 4 where the memory comprises a broadcast station database that stores a name, geographical location coordinates, strength, area of coverage, an alternative frequency, a channel identification, or a program type code for the broadcast station.

6. The system of claim 1 where the system controller further comprises a decision and evaluation unit that evaluates the broadcast station information obtained from the memory with the tuning and measurement results of the tuning receiver and decides a switch-over operation from a first broadcast station to second broadcast station.

7. The system of claim 6 where the geographical location coordinates that identify where a switch-over operation occurred comprise the first and second broadcast stations stored in the memory.

8. The system of claim 7 further comprising a human machine interface (HMI) that outputs a user warning message indicating an upcoming termination of a program when the reception quality parameter has been determined unsatisfactory.

9. The system of claim 8 where the tuning receiver comprises:
a learning receiver that dynamically stores broadcast information related to position data output by the navigation unit in the memory, and
logic for retrieving the stored information when a route related to the stored position data is taken by the vehicle.

10. The system of claim 9 where the system controller further comprises prediction logic for predicting the reception quality parameter for a geographical location other than the present location of the vehicle.

11. The system of claim 10 where the tuning receiver comprises an analog or digital audio tuner, an analog or digital television tuner, or a mobile radio communication receiver.

12. The system of claim 11 where the tuning receiver, the navigation unit, the broadcast station database, the system control unit and the HMI are integrated in a vehicle head unit and communicate with each other by a data bus.

13. A method in a vehicle entertainment and information processing system, comprising:
receiving broadcast signals from a broadcast station;
receiving geographical location coordinates from a GPS unit and outputting position data related to the vehicle's movement;
obtaining broadcast station information from a database; and
determining a reception quality parameter of the broadcast station based on the position data and the broadcast station information.

14. The method of claim 13 further comprising correlating the position data with the broadcast station information and using the correlation in scanning and reception for broadcast signals.

15. The method of claim 13 where the reception quality parameter includes a measure for a reception strength, interference or a signal-to-noise ratio of a received broadcast program.

16. The method of claim 15 further comprising storing the reception quality parameters for a broadcast station in relation to a geographical location of the vehicle.

17. The method of claim 16 where the broadcast station database comprises a name, geographical location coordinates, a signal strength, an area of coverage, an alternative frequency, a channel identification, or a program type code for a broadcast station.

18. The method of claim 17 further comprising evaluating the broadcast station information obtained from the database with the tuning and measurement results and deciding a switch over operation from a first broadcast station to a second broadcast station.

19. The method according to claim 18 comprising storing in the database the geographical location coordinates identifying where a switchover operation occurred.

20. The method of claim 19 where the geographical location coordinates identifying where a switchover operation occurred comprise the identity of the first and second broadcast stations.

21. The method of claim 20 further comprising outputting a user warning message indicating an upcoming termination of a program when the reception quality parameter has been determined unsatisfactory.

22. The method of claim 21 further comprising testing a candidate broadcast station and determining a reception quality parameter before performing a switch over operation.

23. The method of claim 22 further comprising evaluating broadcast station tuning and measurement results related to route data; and storing the evaluated broadcast station results.

24. The method of claim 23 further comprising retrieving the stored broadcast station results when a route coinciding with the stored position data is taken by the vehicle.

25. The method of claim 24 further comprising predicting the reception quality parameter for a geographical location other than the location of the vehicle.

26. The method of claim 25 where the broadcast signals comprise analog or digital radio broadcast signals, television broadcast signals or mobile communication signals.

27. The method of claim 25 where the broadcast station information contained in the database is dynamically updated.

28. The method of claim 27 where the update is performed by an online connection to a server or reading an external memory.

29. The system of claim 1 where the navigation unit comprises a global positioning system (GPS) unit and outputs position data according to the vehicle's movement.
